(19) United States
(12) Patent Application Publication
(10) Pub. No.: US 2014/0014174 A1
(43) Pub. Date: Jan. 16, 2014

(54) DYE-SENSITIZED SOLAR CELL WITH NITROGEN-DOPED CARBON NANOTUBES

(71) Applicant: Egbert Figgemeier, Leichlingen (DE)

(72) Inventor: Egbert Figgemeier, Leichlingen (DE)

(73) Assignee: BAYER INTELLECTUAL PROPERTY GMBH, Monheim (DE)

(21) Appl. No.: 14/008,120

(22) PCT Filed: Mar. 26, 2012
(86) PCT No.: PCT/EP2012/055327

§ 371 Date: Sep. 27, 2013

(30) Foreign Application Priority Data
Mar. 31, 2011 (EP) 11160619.0

(51) Int. Cl. H01G 9/20

(52) U.S. Cl. CPC H01G 9/2018
USPC 136/256

(57) ABSTRACT

A dye-sensitized solar cell comprises a metal oxide electrode, a counter electrode which faces the metal oxide electrode and an electrolyte arranged between the metal oxide electrode and the counter electrode, wherein the metal oxide electrode comprises a dye located thereon and the electrolyte comprises an electrochemical redox pair. Furthermore, between the metal oxide electrode and the counter electrode, nitrogen-doped carbon nanotubes (N-CNTs) are arranged, which are in electrical contact with the counter electrode. The invention further relates to a method of obtaining electrical energy by means of dye-sensitized solar cells according to the invention and to the use of nitrogen-doped carbon nanotubes as catalyst in the reaction of an electrochemical redox pair, in particular of the redox pair I⁻/I₃⁻.

This application is a 371 of International Patent Application No. PCT/EP2012/055327, filed Mar. 26, 2012, which, in turn, claims priority of European Patent Application No. 11160619.0, filed Mar. 31, 2011, the entire contents of which patent applications are incorporated herein by reference.

The present invention relates to a dye-sensitized solar cell, comprising a metal oxide electrode, a counter electrode which faces the metal oxide electrode and an electrolyte arranged between the metal oxide electrode and the counter electrode, wherein the metal oxide electrode comprises a dye located thereon and the electrolyte comprises an electrochemical redox pair. The invention further relates to a method of obtaining electrical energy by means of dye-sensitized solar cells according to the invention and to the use of nitrogen-doped carbon nanotubes as catalyst in the reaction of an electrochemical redox pair.

A dye-sensitized solar cell or Grätzel cell (dye-sensitized nanocrystalline solar cell) is substantially made up of two electrodes, between which a photoelectrochemical process for obtaining electricity takes place. An important component of this solar cell is the counter electrode, on which a redox pair (I⁻/I₃⁻) is reduced to sustain the process. In addition, this counter electrode should contain an efficient catalyst for this redox reaction. This is generally a noble metal-based catalyst, such as e.g. a metallic platinum catalyst. However, the use of noble metals is always associated with high costs, and so alternatives are desirable.

EP 2 061 049 A2 mentions in one embodiment of the dye-sensitized solar cell described there that its second electrode comprises a conductive substrate, which is coated with a platinum layer and/or with a layer of carbon nanotubes. The dye-sensitized solar cell itself comprises a first electrode and a second electrode facing the first electrode with an electrolyte layer located between the first and second electrodes. The first electrode contains a transparent and porous conductive layer and a layer of semiconductor oxide nanoparticles in the pores of the transparent porous conductive layer, which faces the second electrode. Dye molecules are adsorbed into the layer of semiconductor oxide nanoparticles.

However, no references to the function or advantages of the layer of carbon nanotubes are given in EP 2 061 049 A2.

EP 2 256 764 A2 discloses a dye-sensitized solar cell with an electrolyte free from organic solvents, which is capable of very efficient photoelectrical conversion. This patent application also discloses a novel and practical electrolyte which is free from organic solvents for a dye-sensitized solar cell of this type. An electrolyte which is free from organic solvents contains a conductive carbon material, water and an inorganic iodine compound. This electrolyte is preferably a quasi-solid electrolyte and the conductive carbon material in the electrolyte preferably has a surface area of 30 to 300 m²/g. According to this patent application, the use of platinum in the counter electrode can then be omitted. In the examples of this patent application, a commercial form of conductive carbon black is used as the carbon material. The highest photochemical efficiency quoted is 1.82%.

In view of these disadvantages in the prior art, the present invention set itself the object of providing a way of reducing or avoiding the use of expensive noble metal catalysts in dye-sensitized solar cells, which has a higher efficiency than described hitherto.

This object is achieved according to the invention by a dye-sensitized solar cell, comprising:
a metal oxide electrode;
a counter electrode, which faces the metal oxide electrode; and
an electrolyte arranged between the metal oxide electrode and the counter electrode;

wherein the metal oxide electrode comprises a dye located thereon and the electrolyte comprises an electrochemical redox pair, and wherein nitrogen-doped carbon nanotubes, which are in electrical contact with the counter electrode, are arranged between the metal oxide electrode and the counter electrode.

### BRIEF DESCRIPTION OF THE DRAWINGS

The invention will now be described in greater detail with reference to the drawing, wherein:

FIG. 1 is a graph comparing the redox potentials of various electrode materials.

It has been found that nitrogen-doped carbon nanotubes can catalyse the reaction of the electrochemical redox pair located in the solar cell, in particular of the iodide/triiodide redox pair, and thus a high efficiency can be achieved even without a noble metal as catalyst.

Nitrogen-doped carbon nanotubes (N-CNTs) within the framework of the present invention are carbon nanotubes (CNTs) comprising nitrogen atoms and here, in particular, those in the graphene layers of which additional nitrogen atoms are incorporated. Furthermore, it is possible, for example, that nitrogen-doped CNTs have primary, secondary, tertiary and/or quaternary amino groups, which are bonded to the CNTs directly or via other molecule fragments (“spacers”). The bonding states can be identified using X-ray photoelectron spectroscopy for the N1s line. Thus, when excited with monochromatic Al K_{α}, radiation (1486.6 eV), binding energies of between 398 and 405 eV are obtained: for example, for pyridinically bonded nitrogen a binding energy of 398.7+/−0.2 eV, for pyrrolically bonded nitrogen a binding energy of 400.7 eV and for quaternary bonded nitrogen a binding energy of 401.9 eV. The oxidised nitrogen groups are visible in the N1s line at 403 to 405 eV.

The nitrogen-doped CNTs can be present in agglomerated form, in partially agglomerated form or in deagglomerated form.

Several methods of manufacturing N-CNTs are known. Suitable carbon nanotubes as starting material are, in particular, all single-wall or multi-wall carbon nanotubes of the cylinder type (e.g. according to U.S. Pat. No. 5,747,161 and WO 86/03455 A1), scroll type, multi-scroll type, cup-stacked type consisting of conical cups that are closed at one end or open at both ends (e.g. according to EP 0 198 558 A2 and U.S. Pat. No. 7,018,601), or with an onion-like structure. Multi-wall carbon nanotubes of the cylinder type, scroll type, multi-scroll type and cup-stacked type or mixtures thereof should preferably be used. It is favourable if the carbon nanotubes have a ratio of length to external diameter of ≧5, preferably ≧100. Multi-wall carbon nanotubes with an average external diameter of ≧3 nm to ≦100 nm and a ratio of length to diameter of ≧5 are particularly preferred as carbon nanotubes.

WO 2010/127767 A1 discloses a method of manufacturing graphitic carbon materials, which comprise pyridinic, pyrrolic and/or quaternary nitrogen groups at least on their surface, starting from carbon nanotubes, wherein the carbon nanotubes are ground under a nitrogen atmosphere.

DE 10 2007 062 421 A1 describes a method of manufacturing nitrogen-doped carbon nanotubes (NCNTs), which comprises at least the following steps:

a. precipitation of at least one metal (M) from a solution of a metal salt (MS) of the at least one metal (M) in a solvent (L), obtaining a suspension (S) comprising a solid (F),

b. separation and optional after-treatment of the solid (F) from the suspension (S), obtaining a heterogeneous metal catalyst (K),

c. introduction of the heterogeneous metal catalyst (K) into a fluidised bed,

d. reaction of at least one reactant (E), which comprises carbon and nitrogen, or of at least two reactants (E), wherein at least one comprises carbon and at least one comprises nitrogen, in the fluidised bed on the heterogeneous metal catalyst (K), obtaining nitrogen-doped carbon nanotubes (N-CNTs),

e. discharge of the nitrogen-doped carbon nanotubes (N-CNTs) from the fluidised bed.

Examples of suitable metal oxide electrodes are electrodes of titanium dioxide, SnO₂ and/or InO₃. The dye can be directly bonded or applied to the metal oxide electrode. However, it is also possible for one or more suitable intermediate layers also to be located between the metal oxide electrode and the dye. The metal oxide electrode can be present entirely or partially in the form of particles or nanoparticles. Examples of substrates on which the metal oxide electrode can be arranged are indium-zinc oxide (IZO), indium-tin oxide (ITO) and/or FTO, which is obtained by doping SnO₂ with fluorine.

The counter electrode can, in the simplest case, be an electrically conductive material on which the nitrogen-doped CNTs are supported.

The electrolyte can be an aqueous or non-aqueous electrolyte. Moreover, it is possible for the electrolyte to comprise an ionic liquid.

With regard to the dye, no restrictions are initially provided. Thus, the dye can, for example, be a Ru-based metal complex and/or an organic dye, in particular a dye selected from the group consisting of azo dyes, oligoenes, merocyanines or mixtures of these.

The electrochemical redox pair is a reversible redox pair, the redox reaction of which is catalysed by the nitrogen-doped CNTs. After light absorption by the dye, this is excited and emits electrons into the (semiconductive) metal oxide electrode, giving an oxidised form. After passing through an electrical circuit, they reach the counter electrode where, catalysed by the nitrogen-doped CNTs, they reduce the oxidised form of the redox pair. The reduced form of the redox pair is then available to emit electrons directly or indirectly to the oxidised form of the dye.

The present invention is described in more detail below in connection with preferred embodiments. They can be combined in any way, provided that the contrary is not clearly derived from the context.

In one embodiment of the solar cell according to the invention, the electrochemical redox pair comprises an inorganic iodine compound. The electrochemical redox pair is preferably the redox pair I⁻/I₃⁻. These redox pairs can be obtained, for example, by adding iodide, elemental iodine, iodate and/or periodate to the electrolyte.

In another embodiment of the solar cell according to the invention, the counter electrode is free from metals from the group of cobalt, rhodium, iridium, nickel, palladium, platinum, copper, silver and gold. The term “free from” contains, in the context of the present invention, the presence of technically unavoidable traces of said metals, which may have been carried over as a result of the manufacture of the CNTs. In any case, the counter electrode in this embodiment contains no macroscopic areas of these metals in elemental form, as are encountered in the prior art as platinum electrodes, for example.

In another embodiment of the solar cell according to the invention, the nitrogen-doped carbon nanotubes are connected to the counter electrode. The connection can, for example, take place mechanically or by means of a bonding agent. The nitrogen-doped CNTs are then preferably no longer arranged freely in the electrolyte between the two electrodes, but are located only on and in electrical contact with the counter electrode.

In another embodiment of the solar cell according to the invention, the nitrogen-doped carbon nanotubes have a nitrogen content of ≧0.1 at. % to ≦10 at. %. The atom content can be identified by X-ray photoelectron spectroscopy by integrating the signals for the N1s line. A suitable excitation is using monochromatic Al K_{α} radiation (1486.6 eV). Preferred ranges for the nitrogen content are ≧1 at. % to ≦8 at. % and ≧3 at. % to ≦7 at. %. It is also preferred if ≧50% to ≦100% of the nitrogen atoms are present in pyridinic and/or pyrrolic form.

In another embodiment of the solar cell according to the invention, the nitrogen-doped carbon nanotubes comprise pyridinic, pyrrolic and/or quaternary nitrogen groups at least on their surface. As already mentioned, these groups can be identified by their characteristic signals for the N1s line in the X-ray photoelectron spectrum during excitation with monochromatic Al K_{α} radiation (1486.6 eV) by binding energies of between 398 and 405 eV.

In another embodiment of the solar cell according to the invention, the nitrogen-doped carbon nanotubes are obtainable by a method, which comprises the following steps:
precipitation of two metal salts (MS) of the metals (M) cobalt and manganese, together with other components (I) comprising magnesium and aluminium in a solvent (L), obtaining a suspension (S) comprising a solid (F);
separation and optional after-treatment of the solid (F) from the suspension (S), obtaining a heterogeneous metal catalyst (K) of the form M¹:M²:I¹O:I²O, in which
   M¹ is manganese and is present in a proportion by weight of ≧2% to ≦65%,
   M² is cobalt and is present in a proportion by weight of ≧2% to ≦80% ,
   I¹O is Al₂O₃ and is present in a proportion by weight of ≧5% to ≦76% and
   I²O is MgO and is present in a proportion by weight of ≧5% to ≦70% ,
wherein said proportions by weight add up to ≦100%;
introduction of the heterogeneous metal catalyst (K) into a fluidised bed;
reaction of at least one gaseous reactant (E), which comprises a nitrogen-containing organic compound, in the fluidised bed on the heterogeneous metal catalyst (K) at temperatures of between 300° C. and 1600° C., obtaining nitrogen-doped carbon nanotubes;
discharge of the nitrogen-doped carbon nanotubes from the fluidised bed.

The reactant (E) is preferably selected from the list of acetonitrile, dimethylformamide, acrylonitrile, propionitrile, butyronitrile, pyridine, pyrrole, pyrazole, pyrrolidine and/or piperidine.

It is also possible to use, in addition to the at least one reactant (E), another reactant which does not contain any nitrogen. This other reactant is preferably selected from the list of methane, ethane, propane, butane, and/or higher aliphatics, which are present in gaseous form under the conditions in the reaction zone, as well as ethylene, propylene, butene, butadiene and/or higher olefins, which are present in gaseous form under the conditions in the reaction zone, acetylene, or aromatic hydrocarbons, which are present in gaseous form under the conditions in the reaction zone. Other gases preferably comprise hydrogen and/or inert gases. Inert gases preferably comprise noble gases or nitrogen.

The composition of the mixture of gases introduced into the reaction zone generally consists of 0-90 vol. % hydrogen, 0-90 vol. % of an inert gas, such as e.g. nitrogen or argon, and 5-100 vol. % of the at least (E) in the gaseous state of aggregation, preferably 0-50 vol. % hydrogen, 0-80 vol. % of an inert gas, such as e.g. nitrogen or argon, and 10-100 vol. % of the reactant (E) in the gaseous state of aggregation, and particularly preferably 0-40 vol. % hydrogen, 0-50 vol. % of an inert gas, such as e.g. nitrogen or argon, and 20-100 vol. % of the reactant (E) in the gaseous state of aggregation.

In another embodiment of the solar cell according to the invention, the nitrogen-doped carbon nanotubes are obtainable by a method which comprises the grinding of carbon nanotubes under an ammonia, amine and/or nitrogen atmosphere. Suitable as amines are, in principle, primary, secondary and tertiary amines. A preferred variant here contains the grinding of the CNTs under a nitrogen atmosphere with a nitrogen content of at least 90 vol. % in a planetary mill for a period of four to eight hours with an energy input of 500 kJ per gram CNTs to 2500 kJ per gram CNTs.

In another embodiment of the solar cell according to the invention, the dye is selected from the group comprising xanthene dyes, such as Eosin-Y, coumarin dyes, triphenylmethane dyes, cyananine dyes, merocyanine dyes, phthalocyanine dyes, naphthalocyanine dyes, porphyrin dyes, polypyridine metal complex dyes, ruthenium bipyridine dyes, azo dyes, quinone dyes, quinone imine dyes, quinacridone dyes, squarium dyes, perylene dyes, indigo dyes, polymethine dyes and/or riboflavin dyes.

The present invention further provides a method of obtaining electrical energy by means of dye-sensitized solar cells, wherein the solar cell is a solar cell according to the invention.

The present invention further relates to the use of nitrogen-doped carbon nanotubes as a catalyst in the reaction of an electrochemical redox pair, wherein the electrochemical redox pair comprises an inorganic iodine compound. In particular, the electrochemical redox pair is the redox pair I⁻/I₃⁻.

Without being restricted to this, the invention is further explained on the basis of the following example.

### EXAMPLE

### Influencing the Redox Potential of the Redox Pair I⁻/I₃⁻

The reduction potential of the redox pair I⁻/I₃⁻ is a decisive factor affecting the efficiency of the dye-sensitized solar cell. The more positive the reduction potential, the higher the efficiency of the solar cell, as the potential difference between the counter electrode and the Fermi level of the semiconductor decides on the open circuit voltage (V_{OC}).

The I⁻/I₃⁻ reduction is a complex chemical process, which makes it necessary to use catalysts for an effective solar cell. To be able to estimate the potential of N-CNTs as a catalyst, the reduction potentials of I⁻/I₃⁻ in acetonitrile were determined comparatively by voltammetry with various electrodes.

The N-CNTs used were characterised by electron spectroscopy (ESCA) and contained 6.5 at. % nitrogen. Of this 6.5 at. % nitrogen, 75% was present in pyridinic or pyrrolic form and 25% in non-aromatic form.

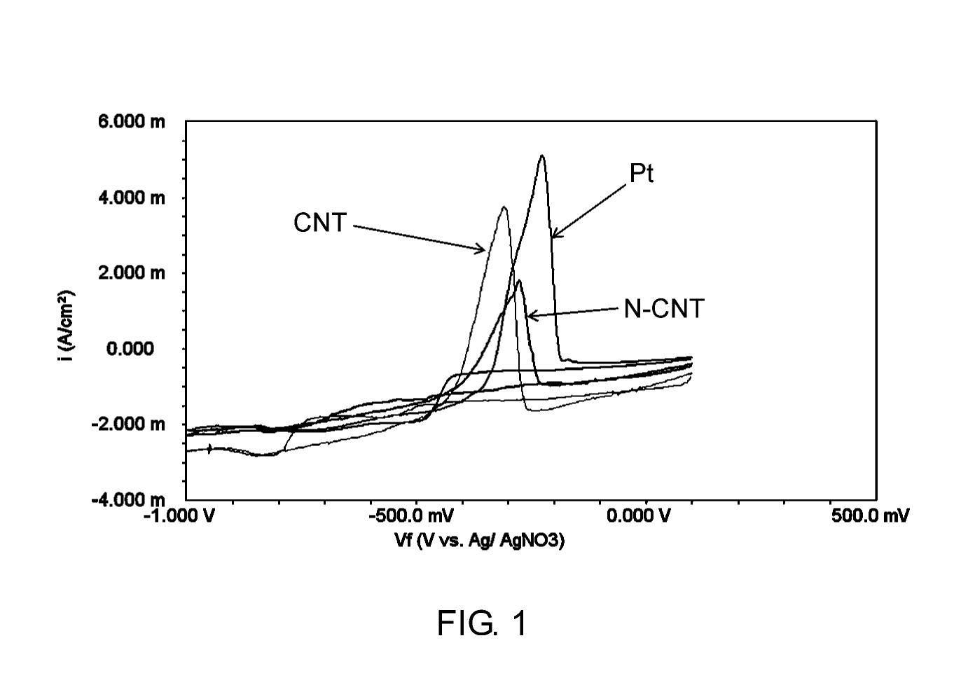

The results are illustrated in FIG. 1. A comparison of the different electrode materials shows a very clear dependency of the reduction potential. It may be observed here that the reduction potential when using N-CNTs (−277 mV vs. Ag/AgNO₃) according to the invention is significantly less negative than with CNT-based electrodes (−309 mV vs. Ag/AgNO₃), but still more negative than with a Pt electrode (−228 mV vs. Ag/AgNO₃).

1. A dye-sensitized solar cell, comprising:
a metal oxide electrode;
a counter electrode, which faces the metal oxide electrode; and
an electrolyte arranged between the metal oxide electrode and the counter electrode;
wherein the metal oxide electrode comprises a dye located thereon and the electrolyte comprises an electrochemical redox pair,
wherein
nitrogen-doped carbon nanotubes, which are in electrical contact with the counter electrode, are arranged between the metal oxide electrode and the counter electrode.

2. The solar cell according to claim 1, wherein the electrochemical redox pair comprises an inorganic iodine compound.

3. The solar cell according to claim 2, wherein the electrochemical redox pair is the redox pair I⁻/I₃⁻.

4. The solar cell according to claim claim 1, wherein the counter electrode is free from metals selected from the group consisting of cobalt, rhodium, iridium, nickel, palladium, platinum, copper, silver and gold.

5. The solar cell according to claim 1, wherein the nitrogen-doped carbon nanotubes are connected to the counter electrode.

6. The solar cell according to claim 1, wherein the nitrogen-doped carbon nanotubes have a nitrogen content of ≧0.1 at. % to ≦10 at. %.

7. The solar cell according to claim 1, wherein the nitrogen-doped carbon nanotubes comprise pyridinic, pyrrolic and/or quaternary nitrogen groups at least on their surface.

8. The solar cell according to claim 1, wherein the nitrogen-doped carbon nanotubes are obtainable by a method which comprises the following steps:
precipitating two metal salts (MS) of the metals (M) cobalt and manganese, together with other components (I) comprising magnesium and aluminium in a solvent (L), obtaining a suspension (S) comprising a solid (F);
separating and optional after-treating of the solid (F) from the suspension (S), obtaining a heterogeneous metal catalyst (K) of the form M¹:M²:I¹O:I²O, in which
M¹ is manganese and is present in a proportion by weight of ≧2% to ≦65%,
M² is cobalt and is present in a proportion by weight of ≧2% to ≦80%,
I¹O is Al₂O₃ and is present in a proportion by weight of ≧5% to ≦76% and
I²O is MgO and is present in a proportion by weight of ≧5% to ≦70%,
wherein said proportions by weight add up to ≦100%;
introducing the heterogeneous metal catalyst (K) into a fluidised bed;
reacting at least one gaseous reactant (E), which comprises a nitrogen-containing organic compound, in the fluidised bed on the heterogeneous metal catalyst (K) at temperatures of between 300° C. and 1600° C., obtaining nitrogen-doped carbon nanotubes;
discharing the nitrogen-doped carbon nanotubes from the fluidised bed.

9. The solar cell according to claim 1, wherein the nitrogen-doped carbon nanotubes are obtainable by a method which comprises the grinding of carbon nanotubes under an ammonia, amine and/or nitrogen atmosphere.

10. The solar cell according to claim 1, wherein the dye is selected from the group consisting of xanthene dyes, coumarin dyes, triphenylmethane dyes, cyananine dyes, merocyanine dyes, phthalocyanine dyes, naphthalocyanine dyes, porphyrin dyes, polypyridine metal complex dyes, ruthenium bipyridine dyes, azo dyes, quinone dyes, quinone imine dyes, quinacridone dyes, squarium dyes, perylene dyes, indigo dyes, polymethine dyes, and riboflavin dyes and mixtures thereof.

11. A method of obtaining electrical energy by means of dye-sensitized solar cells, wherein the solar cell is a solar cell according to claim 1.

12. Method for using nitrogen-doped carbon nanotubes as catalyst in the reaction of an electrochemical redox pair, wherein the electrochemical redox pair comprises an inorganic iodine compound.

13. Method according to claim 12, wherein the electrochemical redox pair is the redox pair I⁻/I₃⁻.
